(19) United States
(12) Patent Application Publication
(10) Pub. No.: US 2025/0092269 A1
(43) Pub. Date: Mar. 20, 2025

(54) ANTI-BIOFOULING COMPOSITION

(71) Applicant: Montana Technological University, Butte, MT (US)

(72) Inventors: Amos Taiswa, Butte, MT (US); Jack L. Skinner, Butte, MT (US); Jessica M. Andriolo, Butte, MT (US)

(21) Appl. No.: 18/885,403

(22) Filed: Sep. 13, 2024

Related U.S. Application Data
(60) Provisional application No. 63/538,625, filed on Sep. 15, 2023.

(51) Int. Cl. C09D 5/16; A01N 25/10; A01N 43/16; A01P 1/00; C09D 167/04

(52) U.S. Cl. CPC C09D 5/1625; A01N 25/10; A01N 43/16; A01P 1/00; C09D 5/1637; C09D 167/04

(57) ABSTRACT

Disclosed herein is a composition comprising a polymeric mixture comprising a hydrophobic component and a hydrophilic component, wherein the hydrophobic component has a lower water solubility than the hydrophilic component; and one or more molecules for disrupting bacterial communication. Also disclosed herein are methods of making and using the composition disclosed herein.

### CROSS REFERENCE TO RELATED APPLICATION

This application claims the benefit of and priority to the earlier filing date of U.S. Provisional Application No. 63/538,625, filed on Sep. 15, 2023, the entirety of which is incorporated herein by reference.

### ACKNOWLEDGMENT OF GOVERNMENT SUPPORT

This invention was made with government support under Contract No. OIA-1757351 awarded by the National Science Foundation. The government has certain rights in the invention.

This invention is based upon work supported in part by the National Science Foundation EPSCoR Cooperative Agreement OIA-1757351. This material is based upon work supported in part by the National Science Foundation EPSCoR Cooperative Agreement OIA-1757351. Any opinions, findings, and conclusions or recommendations expressed in this material are those of the author(s) and do not necessarily reflect the views of the National Science Foundation.

### FIELD

The present disclosure concerns a composition and methods of making and using the same for reducing biofouling or the formation of biofilm by releasing one or more molecules that disrupt bacterial communication systems in biofouling or biofilm formation.

### BACKGROUND

Membrane technology continues to be a key area of research that enables access to safe drinking water around the world. Membrane filtration reportedly contributes greater than 50% of the total world water treatment volume. Despite its advancement, the problematic deposition and growth of biofilms on membrane-based filtration systems remains a costly issue that reduces clean water output. Biofilms are sessile structures constructed by bacteria that primarily consist of extracellular polymeric substances that biofilm-producing bacteria, such as Pseudomonas aeruginosa (PAO), utilize to adhere to surfaces in aqueous environments. This complex matrix provides a safe haven for embedded microorganisms, that exhibit high resistance behavior within the film as compared to single cells. Biofilms are therefore hard to treat and create a perpetual blockage that resists flow through membranes.

Several methods have been investigated to mitigate membrane biofouling. These techniques include: pretreatment of feed water to reduce nutrient concentrations and slow kinematics of biofouling, membrane surface grafting, biocidal surface coatings, and physical surface modifications. Pretreatment of feed water is untenable long term due to high costs, need for disposal of undesired by-products, and possible production of assimilable organic carbon and carcinogenic byproducts. Drawbacks to membrane surface grafting include introduction of materials that can reduce long-term acceptable permeate flux and salt rejections, while biocidal surface coatings are problematic due to instability and toxicity. While physical modifications can be low cost, long-term, and non-toxic, research has shown this method may discourage adherence of one microbial species while encouraging adherence of another.

Accordingly, there is a need in the art for new compositions and methods for treating and disrupting bacterial communication systems that lead to biofilm formation.

### SUMMARY

Disclosed herein are aspects of a composition, comprising a polymeric mixture comprising a hydrophobic component and a hydrophilic component, wherein the hydrophobic component has a lower water solubility than the hydrophilic component; and one or more molecules for disrupting bacterial communication.

Also disclosed herein is a membrane, comprising a substrate; and a polymeric antibiofouling coating comprising: a polymer blend, block copolymer, or block copolymer blend, and one or more molecules for disrupting bacterial communication; wherein the polymeric antibiofouling coating is deposited onto the substrate via electrospinning.

A method for inhibiting membrane biofilm formation is also disclosed herein, the method comprising depositing the composition disclosed herein onto a substrate via electrospinning; and exposing the substrate to an aqueous environment.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a schematic illustrating aspects of an electrospinning system disclosed herein.

FIG. 2 is a schematic illustrating a bench scale nanofiltration system for monitoring water output efficiencies and biofilm formation on water filtration membranes.

FIG. 3A is a field emission scanning electron microscopy (FESEM) micrograph showing electrospun fibers prior to a filtration test.

FIG. 3B is a field emission scanning electron microscopy (FESEM) micrograph showing electrospun fibers after a filtration test.

FIG. 4A is a confocal microscopy (CLSM) image showing the biofilm growth on the membrane after 4-hour operation under an unmodified MCE membrane.

FIG. 4B is a confocal microscopy (CLSM) image showing the biofilm growth on the control PCL/PEG fibers layered on the membrane.

FIG. 4C is a confocal microscopy (CLSM) image showing the biofilm growth on the fibers associated with anti-QS Urolithin A.

FIG. 4D is a graph showing the biovolume (μm³/μm²) quantitative data and comparing the results for the unmodified membrane of FIG. 4A, control PCL/PEG fibers of FIG. 4B, and the fibers associated with anti-QS Urolithin A of FIG. 4C.

FIG. 4E is a graph showing the thickness (μm) quantitative data and comparing the results of the unmodified membrane of FIG. 4A, control PCL/PEG fibers of FIG. 4B, and the fibers associated with anti-QS Urolithin A of FIG. 4C.

FIG. 4F is a graph showing membrane performance in terms of water quantity output of average flux (L M⁻² h⁻¹) after operation and comparing the results for the unmodified membrane of FIG. 4A, control PCL/PEG fibers of FIG. 4B, and the fibers associated with anti-QS Urolithin A of FIG. 4C.

FIG. 4G is a graph showing the membrane performance in terms of water quantity output of filtered volume (mL) after operation and comparing the results for the unmodified membrane of FIG. 4A, control PCL/PEG fibers of FIG. 4B, and the fibers associated with anti-QS Urolithin A of FIG. 4C.

FIG. 5A is an image of an electrospun filter comprising PCL/PEG fibers associated with one or more anti-QS Urolithin A molecules.

FIG. 5B is an electron micrograph of the electrospun filter comprising PCL/PEG fibers associated with one or more anti-QS Urolithin A molecules of FIG. 5A.

FIG. 6A is a confocal microscopy (CLSM) image showing the biofilm growth on an unmodified control membrane.

FIG. 6B is a confocal microscopy (CLSM) image showing the biofilm growth on a membrane comprising electrospun PCL/PEG fibers associated with one or more anti-QS Urolithin A molecules (50 μg/mL).

FIG. 6C is a confocal microscopy (CLSM) image showing the biofilm growth on a membrane comprising electrospun PCL/PEG fibers associated with one or more anti-QS Urolithin A molecules (100 μg/mL).

FIG. 6D is a confocal microscopy (CLSM) image showing the biofilm growth on a membrane comprising electrospun PCL/PEG fibers associated with one or more anti-QS Urolithin A molecules (200 μg/mL).

FIG. 7 is a graph showing biovolume quantitative data (μm³/μm²) and comparing the results of an unmodified multi cellulose ester (MCE) membrane, a MCE membrane comprising electrospun PCL/PEG fibers, and a MCE membrane comprising electrospun PCL/PEG fibers associated with one or more anti-QS Urolithin A molecules.

FIG. 8A is a scanning electron micrograph image showing the biofilm biovolume after a 4-hour filtration test of a MCE filter comprising electrospun PCL/PEG fibers.

FIG. 8B is a scanning electron micrograph image showing the biofilm biovolume after a 4-hour filtration test of a MCE filter comprising electrospun PCL/PEG fibers associated with one or more anti-QS furanone C-30 molecules.

### DETAILED DESCRIPTION

### I. Overview of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing aspects from discussed prior art, the numbers are not approximates unless the word “about” is recited. Furthermore, not all alternatives recited herein are equivalents.

To facilitate review of the various aspects of the present disclosure, the following explanations of specific terms are provided:

Anti-Quorum Sensing (Anti-QS): Altering the quorum sensing process such that coordination of gene expression and process regulation in microbial communities are impaired or prevented.

Biofilm: An assembly of microorganisms wherein cells stick to each other on the surface of a substrate.

Block Copolymer: Polymer containing long stretches of two or more structurally distinct monomeric units linked together by chemical valences in one single chain.

Electrospinning (ES): A method that introduces liquid polymer through a spinneret (conductive, hollow needle) into an electrostatic field. Initiation of voltage on a conductive deposition surface opposite the spinneret results in a voltage differential and charge buildup at the surface of the polymer bead. Once this charge reaches a target value, the polymer bead deforms and stretches into a jet that whips around as it approaches the deposition surface, thereby enhancing solvent evaporation. The result of ES is a solventless polymer fiber mat with nano to micro-sized fibers and high surface area. Desired surface morphologies or configurations of electrospun fibers can be achieved by varying ES and polymer parameters.

Polymer: A macromolecule formed by the chemical union of five or more identical combining units called monomers.

Powder: A composition comprising dispersed solid particles that are relatively free flowing from one another.

Quorum Sensing (QS): The process by which bacteria produce and detect signaling molecules with which to coordinate gene expression and regulate processes beneficial to the microbial community.

Quorum Quencher (QQ): Heterologous or homologous molecules that inhibit QS and/or the formation of biofilms and/or reduce bacterial pathogenicity.

### II. Introduction

Biofouling or the formation of biofilms on surfaces such as water filtration membranes is a critical issue that has resulted in less efficient clean water output, hard to clean surfaces, and reduced efficiencies. Therefore, water filtration membranes are non-feasible for use in regions of the world that do not have readily accessible water sources.

Bacterial communication systems are critical to biofilm formation. Bacterial communication occurs through release and reception of chemical signaling molecules that (among other phenotypes) regulate biofilm formation. Quorum sensing (QS) is the use of autocrine signaling between bacteria in response to bacterial population density that results in altered gene regulation. In particular, QS results in beneficial microbial phenotypes being exhibited depending on whether the bacterial population density is high or low. In low concentrations bacteria detect low autoinducer signaling, and because biofilm formation is not a beneficial phenotype at low concentration, the microbes do not form a biofilm.

Disclosed herein is a composition that disrupts bacterial communication mechanisms preventing and lowering biofilm growth. More specifically, a polymeric mixture comprising a hydrophobic and hydrophilic component provide extended release of anti-QS molecules to prevent biofouling. Also disclosed herein is a polymeric antibiofouling coating comprising the composition disclosed herein deposited onto a substrate via electrospinning resulting in lower biofilm growth and higher water outputs.

### III. Composition

Disclosed herein is a composition comprising a polymeric mixture comprising a hydrophobic component and a hydrophilic component, wherein the hydrophobic component has a lower water solubility than the hydrophilic component; and one or more molecules for disrupting bacterial communication. In certain aspects, the polymeric mixture comprises a polymer blend, a block copolymer, or a block copolymer blend.

In some aspects, the hydrophobic component can be selected from hydrocarbon polymers, carbonyl-containing polymers, and haloaliphatic polymers. Representative hydrocarbon polymers can include, but are not limited to, polyalkylenes, such as polyethylene, polypropylene, polystyrene, or any combination thereof. In certain aspects, the carbonyl-containing polymers can be selected from polyesters. Representative carbonyl-containing polymers can include, but are not limited to, polycaprolactone (PCL), polylactic acid (PLA), poly(1-lactide), polymethyl methacrylate (PMMA) or any combination thereof. Representative hydrophobic haloaliphatic polymers can include, but are not limited to, fluorinated polyethylene polymers and fluorinated polypropylene polymers.

In aspects disclosed herein the hydrophilic component can be selected from heteroaliphatic and starch e.g., saccharide-based polymers. Heteroaliphatic polymers can include, but are not limited to, polyalkylene glycols, polyalkylene oxides, polyvinyl alcohols, polyamides, or any combination thereof. Representative heteroaliphatic polymers can include polyethylene glycol (PEG) polyethylene oxide (PEO), poly(N-isopropylacrylamide (PNIPAM), or any combination thereof. Representative saccharide-based polymers can include, but are not limited to, alkyl cellulose, hydroxyalkyl celluloses, cellulose ethers, cellulose esters, nitro celluloses, methyl cellulose, ethyl cellulose, hydroxypropyl cellulose, alginate, hydroxy-propyl methyl cellulose, hydroxybutyl methyl cellulose, cellulose acetate, cellulose propionate, cellulose acetate butyrate, cellulose acetate phthalate, carboxylethyl cellulose, cellulose triacetate, cellulose sulphate sodium salt, dextran, chitosan, or any combination thereof.

In certain aspects, the polymeric blend may comprise, but is not limited to, a PCL/PEG blend, a PMMA/chitosan blend, a PMMA/PEO blend, a PMMA/PVA blend, a PS/PNIPAM blend, a poly(l-lactide)/poly(vinyl alcohol) blend, or a PLA/starch blend.

In particular aspects disclosed herein, the block copolymer can be, but is not limited to, polyethylene-co-octene (PE), poly(styrene-co-acrylonitrile) (PSA), poly(styrene-co-methyl methacrylate) (PSM), poly(vinylidene fluoride-co-trifluoroethylene), amphiphilic block copolymer poly(ethylene oxide)-b-poly(propylene oxide)-b-poly(ethylene oxide) (PEO-PPO-PEO), polycaprolactone-block-polytetrahydrofurane-block polycaprolactone, poly(ethylene oxide)-block-polycaprolactone, poly(ethylene glycol)-block-poly(e-caprolactone)methyl ether.

In some aspects, the block copolymer blend may comprise PSA/PVA blend, a PSM/PVA blend, a PE/PEO blend, or poly(vinylidene fluoride-co-trifluoroethylene) P(VDF-TrFE)/PEO blend.

In aspects disclosed herein, the hydrophobic component and the hydrophilic component are present in amounts providing a hydrophobic component: hydrophilic component ratio ranging from 5:1 to 1:5 such as from 4:1 to 1:4, 3:1 to 1:3, 2:1 to 1:2. In one such aspect, polycaprolactone and polyethylene glycol are present in amounts providing a polycaprolactone: polyethylene glycol ratio of 3:1 to 1:3.

In particular aspects disclosed herein, the hydrophobic component can have a molecular weight ranging from 5,000 to 500,000, such as from 5,000 to 100,000, 5,000 to 75,000, 5,000 to 50,000, 5,000 to 25,000, 5,000 to 15,000, or 5,000 to 10,000. In certain aspects, the hydrophilic component can have a molecular weight ranging from 200 to 1,000,000, such as from 200 to 750,000, 200 to 500,000, 200 to 250,000, 200 to 100,000, 200 to 75,000, 200 to 50,000, 200 to 25,000, 200 to 15,000, 200 to 10,000, 200 to 5,000, or 200 to 1,000. In aspects disclosed herein, the hydrophobic component can comprise polycaprolactone having a molecular weight ranging from 5,000 to 100,000; and the hydrophilic component can comprise polyethylene glycol having a molecular weight ranging from 200 to 100,000.

In aspects disclosed herein, the one or more molecules for disrupting bacterial communication can comprise an anti-quorum sensing molecule, a derivative, or analogue thereof; or a quorum quenching molecule, a derivative, or analogue thereof; or any combination thereof. In certain aspects, the one or more molecules for disrupting bacterial communication can be selected from, but are not limited to, Urolithin A, Furanone C-30, Curcumin Longa, AHL-lactonase, embelin, Piperine, Piericidin A, Glucopiericidin A, Baicalein, Quercetin, or any combination thereof.

In particular aspects disclosed herein, the one or more molecules for disrupting bacterial communication are incorporated into the composition and associated with the polymeric mixture by mixing, sonication, or any combination thereof. As such, the one or more molecules for disrupting bacterial communication are associated with the polymeric mixture. In some aspects, the one or more molecules for disrupting bacterial communication are mixed with an agitator such as, but not limited to; a magnetic stir bar or device; blending by sonication; mechanical stirring; shaking or similar agitation; or any combination thereof.

In some aspects, the one or more molecules for disrupting bacterial communication can have a concentration in the composition ranging from 1 ug/mL to 5,000 ug/mL, such as from 1 ug/mL to 2,000 ug/mL, 1 ug/mL to 1,000 ug/mL, 1 ug/mL to 900 ug/mL, 1 ug/mL to 800 ug/mL, 1 ug/mL to 700 ug/mL, 1 ug/mL to 600 ug/mL, 1 ug/mL to 500 ug/mL, 1 ug/mL to 400 ug/mL, 1 ug/mL to 300 ug/mL, 1 ug/mL to 200 ug/mL, or 1 ug/mL to 100 ug/mL, or 1 ug/mL to 50 ug/mL. In one such aspect, the one or more molecules for disrupting bacterial communication comprises Urolithin A having a concentration in the composition ranging from 1 ug/mL to 1000 ug/mL.

Also disclosed herein is a membrane comprising a substrate; and a polymeric antibiofouling coating, wherein the polymeric antibiofouling coating is deposited onto the substrate via electrospinning. In aspects disclosed herein, the polymeric antibiofouling coating comprises the composition disclosed herein. In certain aspects, the polymeric antibiofouling coating comprises a polymer blend, a block copolymer, or a block copolymer blend; and one or more molecules for disrupting bacterial communication.

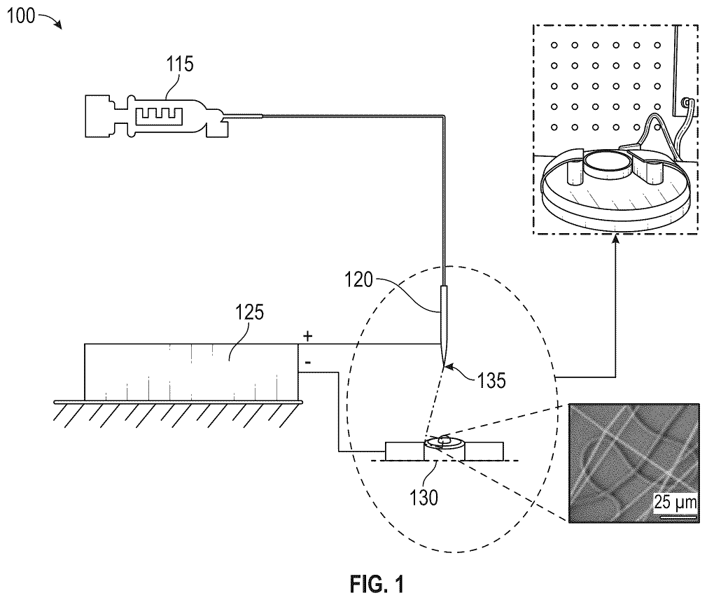

In aspects disclosed herein, the is deposited by using the electrospinning system 100 illustrated in FIG. 1. More specifically, a pump 110, such as, but not limited to, a syringe feeds the composition 115 disclosed herein through a spinneret 120 (conductive, hollow needle) and into an electrostatic field. Initiation of voltage by a voltage supplier 125 on a conductive deposition surface 130 opposite the spinneret 120 results in a voltage differential and charge buildup at the surface of the polymer bead. Once this charge reaches a target value, the polymer bead deforms and stretches into a jet that whips around 135 as it approaches the deposition surface 130, thereby increasing solvent evaporation, and resulting in a polymeric antibiofouling coating fiber mat with nano to micro-sized fibers and high surface area.

In some aspects, the polymeric antibiofouling coating is deposited onto the substrate as a film or sheet layer. In aspects disclosed herein the substrate can be a polymer article. In certain aspects, the polymer article may comprise but is not limited to, cellulose, mixed cellulose ester, polyamide, polyvinylidene fluoride (PVDF), polycaprolactone (PCL), polyether sulfone (PES), polytetrafluoroethylene (PTFE), polypropylene, polycarbonate, or any combination thereof.

In certain aspects, the polymeric antibiofouling coating is an electrospun core-shell structure having a polymeric core comprising the one or more molecules for disrupting bacterial communication. In particular aspects disclosed herein, the polymeric antibiofouling coating is an electrospun core-shell structure having a solid or powder-based core comprising the one or more molecules for disrupting bacterial communication. In some aspects, the polymeric antibiofouling coating is an electrospun core-shell structure having a liquid core.

In aspects disclosed herein, the polymeric core, powder-based core, solid core and liquid core enable the release of the one or more molecules for disrupting bacterial communication by passive and/or activated mechanisms. In certain aspects, the core-shell fibers comprise one or more nanoparticles, wherein the one or more nanoparticles are associated with the core. For example, one or more nanoparticles can be embedded in the core that respond to light by heating and melting one or more pores in the fiber cores, thereby releasing the core components such as, but not limited to, one or more molecules for disrupting bacterial communication.

In aspects disclosed herein, the polymeric antibiofouling coating comprises one or more fibers having a diameter ranging from greater than 0 μm to 20 μm, such as from 0.05 μm to 10 μm, 1 μm to 10 μm, 2 μm to 10 μm, 3 μm to 10 μm, 4 μm to 10 μm, 5 μm to 10 μm, 6 μm to 10 μm, 7 μm to 10 μm, 8 μm to 10 μm, or 9 μm to 10 μm.

### IV. Method of Using

Also disclosed herein is a method of inhibiting membrane biofilm formation, the method comprising: depositing the composition disclosed herein onto a substrate via electrospinning; and exposing the substrate to an aqueous environment. In aspects disclosed herein, the method disclosed herein provides the controlled release of the one or more molecules for disrupting bacterial communication from the electrospun polymeric antibiofouling coating.

Without being bound by a single operating theory, the hydrophilic polymer dissolves from the electrospun polymeric antibiofouling coating and the hydrophobic polymer maintains the structure of the polymeric antibiofouling coating and controls the release of the one or more molecules for disrupting bacterial communication. As such, the electrospun polymeric antibiofouling coating provides the controlled release of the one or more molecules for disrupting bacterial communication.

In some aspects, the one or more small molecules can be anti-quorum sensing molecule; a derivative, or analogue thereof; or a quorum quenching molecule, a derivative, or analogue thereof; or any combination thereof. In certain aspects, the one or more molecules for disrupting bacterial communication can be selected from, but are not limited to, Urolithin A, Furanone C-30, Curcumin Longa, AHL-lactonase, embelin, Piperine, Piericidin A, Glucopiericidin A, Baicalein, Quercetin, or any combination thereof.

In some aspects, the method can inhibit the formation of Pseudomonas aeruginosa, Staphylococcus aureus, Staphylococcus epidermidis, Pseudomonas aeruginosa, Enterococcus faecalis, Escherichia coli, Klebsiella pneumoniae, Proteus mirabilis, Streptococcus viridans, Sphingomonas, Listeria monocytogenes, Salmonella spp., Clostridium perfringens, Bacillus spp., Shewanella putrefaciens, Cronobacter spp., Geobacillus stearothermophilus, or any combination thereof.

Without being bound to a single operating theory, the one or more molecules for disrupting bacterial communication inhibit quorum sensing by inhibiting signal molecule synthesis, inactivation of enzymatic degradation of signal molecules, compete with signal molecules-receptor analogues, and/or block signal transduction cascades.

In aspects disclosed herein, the method can inhibit biofilm formation on one or more polymer articles. Representative polymer articles can include component parts of various devices, equipment, machines, that are either water-bearing or that are exposed to liquids and/or high humidity for prolonged periods of time. In certain aspects, the polymer article can be a water filtration membrane including but not limited to reverse osmosis, dialysis and ion selective membranes and filters including filter papers, cloths, substrate filter beds.

### V. Overview of Several Aspects

Disclosed herein are aspects of a composition, comprising a polymeric mixture comprising a hydrophobic component and a hydrophilic component, wherein the hydrophobic component has a lower water solubility than the hydrophilic component; and one or more molecules for disrupting bacterial communication.

In any or all aspects, the polymeric mixture comprises a polymer blend, a block copolymer, or a block copolymer blend.

In any or all the above aspects, the hydrophobic component comprises polycaprolactone (PCL), polyethylene-co-octene (PE), polylactic acid (PLA), poly(1-lactide), polystyrene, poly(styrene-co-acrylonitrile) (PSA), poly(styrene-co-methyl methacrylate) (PSM), poly(vinylidene fluoride-co-trifluoroethylene), polymethyl methacrylate (PMMA), or any combination thereof; and wherein the hydrophilic component comprises polyethylene glycol (PEG), polyethylene oxide (PEO), poly(vinyl alcohol), poly(n-isopropylacrylamide) (PNIPAM), starch, chitosan, or any combination thereof.

In any or all the above aspects, the hydrophobic component comprises polycaprolactone and the hydrophilic component comprises polyethylene glycol, and the polycaprolactone and the polyethylene glycol are present in amounts providing a polycaprolactone: polyethylene glycol ratio of 3:1 to 1:3.

In any or all the above aspects, the hydrophobic component comprises polycaprolactone having a molecular weight ranging from 5,000 to 100,000; and wherein the hydrophilic component comprises polyethylene glycol having a molecular weight ranging from 200 to 1,000,000.

In any or all the above aspects, the one or more molecules for disrupting bacterial communication comprises an anti-quorum sensing molecule, a derivative, or analogue thereof; or a quorum quenching molecule, a derivative, or analogue thereof; or any combination thereof.

In any or all the above aspects, the one or more molecules for disrupting bacterial communication are selected from Urolithin A, Furanone C-30, Curcumin Longa, AHL-lactonase, embelin, Piperine, Piericidin A, Glucopiericidin A, Baicalein, Quercetin, or any combination thereof.

In any or all the above aspects, the one or more molecules for disrupting bacterial communication comprises Urolithin A having a concentration in the composition ranging from 1 μg/mL to 1000 μg/mL.

In any or all the above aspects, the one or more molecules for disrupting bacterial communication are incorporated into the polymeric mixture by mixing, sonication, or any combination thereof.

Also disclosed herein are aspects of a membrane comprising a substrate; and a polymeric antibiofouling coating comprising: a polymer blend, block copolymer, or block copolymer blend, and one or more molecules for disrupting bacterial communication; wherein the polymeric antibiofouling coating is deposited onto the substrate via electrospinning.

In any or all the above aspects, one or more molecules for disrupting bacterial communication; wherein the polymeric antibiofouling coating is deposited onto the substrate via electrospinning.

In any or all the above aspects, the polymeric antibiofouling coating is an electrospun core-shell structure having a polymeric core comprising the one or more molecules for disrupting bacterial communication.

In any or all the above aspects, the polymeric antibiofouling coating is an electrospun core-shell structure having a solid or powder-based core comprising the one or more molecules for disrupting bacterial communication.

In any or all the above aspects, the polymeric antibiofouling coating is deposited as a film or sheet layer.

In any or all the above aspects, the substrate comprises cellulose, mixed cellulose ester, polyamide, polyvinylidene fluoride (PVDF), polycaprolactone (PCL), polyether sulfone (PES), polytetrafluoroethylene (PTFE), polypropylene, polycarbonate, or any combination thereof.

In any or all the above aspects, the polymeric antibiofouling coating comprises one or more fibers having a diameter ranging from greater than 0 μm to 10 μm.

In any or all the above aspects, the one or more molecules for disrupting bacterial communication inhibit quorum sensing.

A method for inhibiting biofilm formation is also disclosed herein, the method comprising depositing the composition of claim 1 onto a substrate via electrospinning; and exposing the substrate to an aqueous environment.

In any or all the above aspects, wherein the bacterial biofilm comprises Pseudomonas aeruginosa, Staphylococcus aureus, Staphylococcus epidermidis, Pseudomonas aeruginosa, Enterococcus faecalis, Escherichia coli, Klebsiella pneumoniae, Proteus mirabilis, Streptococcus viridans, Sphingomonas, Listeria monocytogenes, Salmonella spp., Clostridium perfringens, Bacillus spp., Shewanella putrefaciens, Cronobacter spp., Geobacillus stearothermophilus, or any combination thereof.

In any or all the above aspects, the one or more small molecules are an anti-quorum sensing molecule; a derivative, or analogue thereof; or a quorum quenching molecule, a derivative, or analogue thereof; or any combination thereof.

In any or all the above aspects, the one or more molecules for disrupting bacterial communication are selected from Urolithin A, Furanone C-30, Curcumin Longa, AHL-lactonase, embelin, Piperine, Piericidin A, Glucopiericidin A, Baicalein, Quercetin, or any combination thereof.

### VI. Examples

Polymeric Component: A polymer blend for electrospinning was prepared comprising 3 wt. % PEG (8,000 MW, Sigma Aldrich) and 8.9 wt. % PCL (80,000 MW, Sigma Aldrich) in chloroform. The PEG/PCL polymer blend was stirred with a Teflon coated stir bar at 80° C. until no visible polymer weas present.

Anti-Quorum Sensing Molecules: The polymeric component comprising the polymer blend was seeded with Urolithin A at a concentration of 200 μg/mL during mixing. Fiber mats comprising Urolithin A were stored at 4-8° C. for preservation prior to application.

Electrospinning: The polymeric component comprising the polymer blend was pumped continuously by a syringe pump at a fixed rate of 0.250 mL/hour to a vertical Spraybase electrospinner equipped with a 22-guage needle at a voltage of 6.6 kV and grounded equidistant copper-plated parallel electrodes for uniaxially aligned deposition (parallel gap electrospinning). A separation distance of 4 cm between the needle and grounded electrodes were maintained for 20 minutes while the fiber mat was fabricated. Fiber mats were rotated at 10 minutes to achieve a crosshatch filter pattern. Fibers were then placed onto MCE membranes and investigated for their controlled release of the anti-QS molecules.

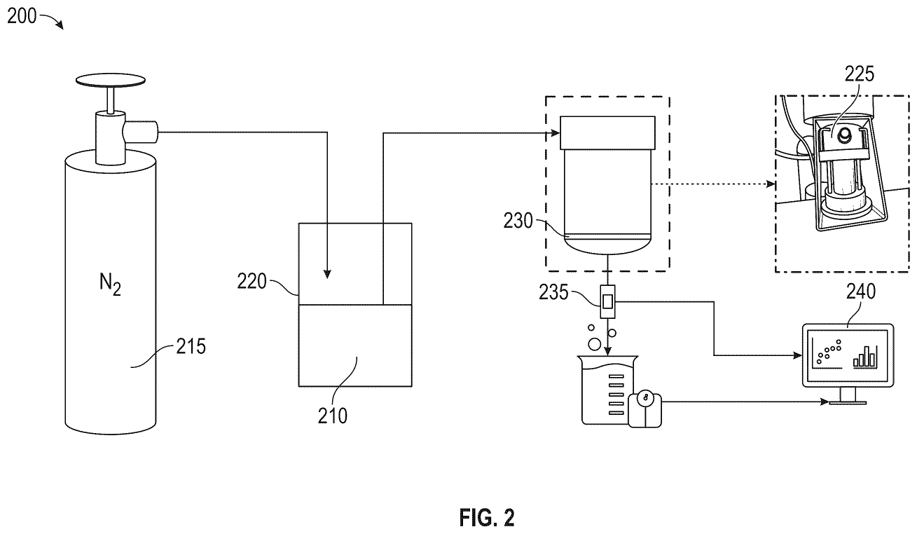

Bench Scale Nanofiltration System: A bench scale nanofiltration system for monitoring water output efficiencies and biofilm formation on MCE membranes was used as illustrated in FIG. 2. More specifically, FIG. 2 shows a bench scale nanofiltration system 200 equipped with a feed 210 that is pressurized with nitrogen gas 215 via a pressure vessel 220 and fed to a filtration module 225 comprising the membrane 230, wherein one or more devices (e.g., flow meter) 235 measure the water output efficiencies and biofilm formation for data acquisition 240.

### Example 1

In this example, electrospun fibers were subjecting to filtration test using the bench scale nanofiltration system for a period of four hours. The morphology of the electrospun fibers were investigated before and after the filtration test.

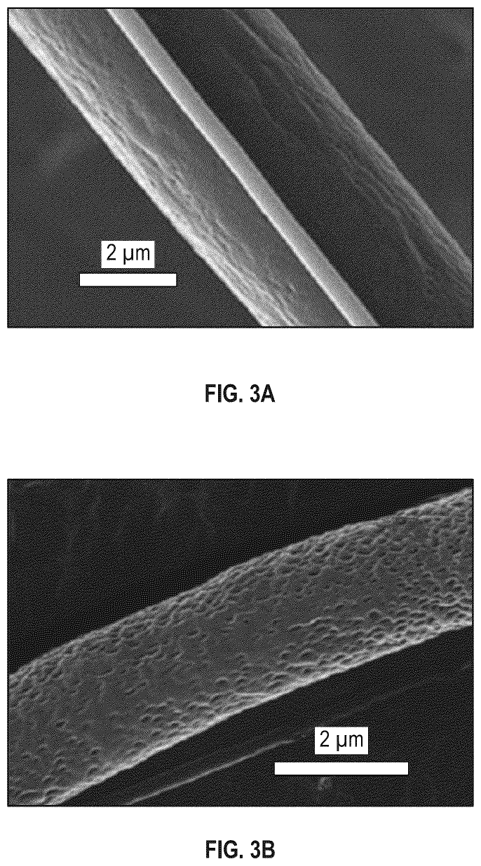

FIG. 3A is a field emission scanning electron microscopy (FESEM) micrograph showing electrospun fibers prior to the filtration test. In view of FIG. 3A, the electrospun fibers exhibited smooth morphologies prior to the nanofiltration tests. FIG. 3B is a field emission scanning electron microscopy (FESEM) micrograph showing electrospun fibers after a filtration test. In view of FIG. 3B, the fibers became porous in portions where PEG had dissolved.

Therefore, this example demonstrates that the polymeric component comprising a PCL/PEG polymer blend (3:1 PCL:PEG ratio) maintained a suitable structure through its hydrophobic polymer, PCL, and the hydrophilic polymer, PEG, would dissolve at a desirable rate to release of one or more anti-QS molecules.

### Example 2

In this example, biofouling on filtration membranes was investigated by examining anti-quorum sensing molecules in P. aeruginosa (PAO1). More specifically, a membrane comprising an unmodified membrane (referred to “MCE Control”); a membrane (referred to as “Control Fibers”) comprising a filter coating, which was deposited by electrospinning fibers comprising a polymer blend (3:1 polycaprolactone (PCL) to polyethylene glycol (PEG)); and a membrane (referred to as “Anti-QS Fibers” comprising a filter coating, which was deposited by electrospinning fibers comprising a polymer blend (3:1 polycaprolactone (PCL) to polyethylene glycol (PEG)) associated with one or more anti-QS molecules (200 μg/mL). Biofilm growth over a 4-hour operation was investigated and compared for the MCE Control, Control Fibers, and Anti-QS Fibers.

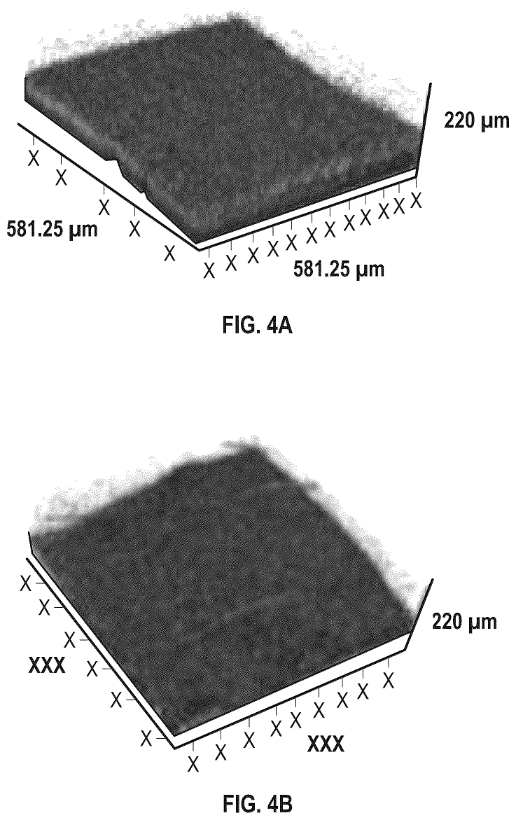

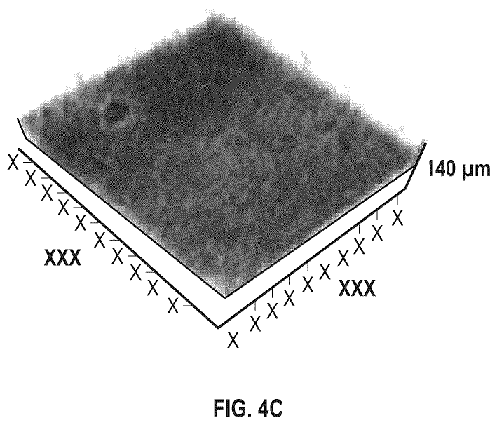

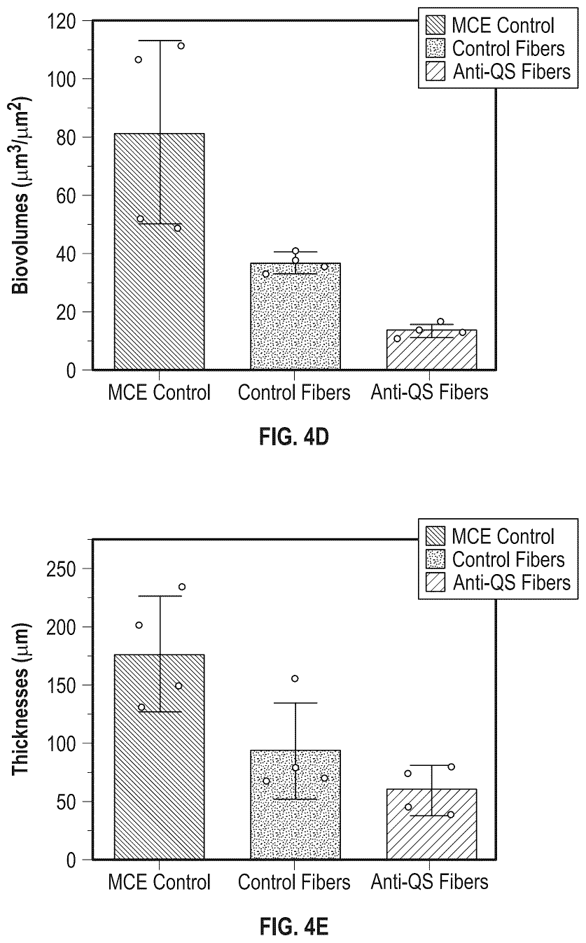

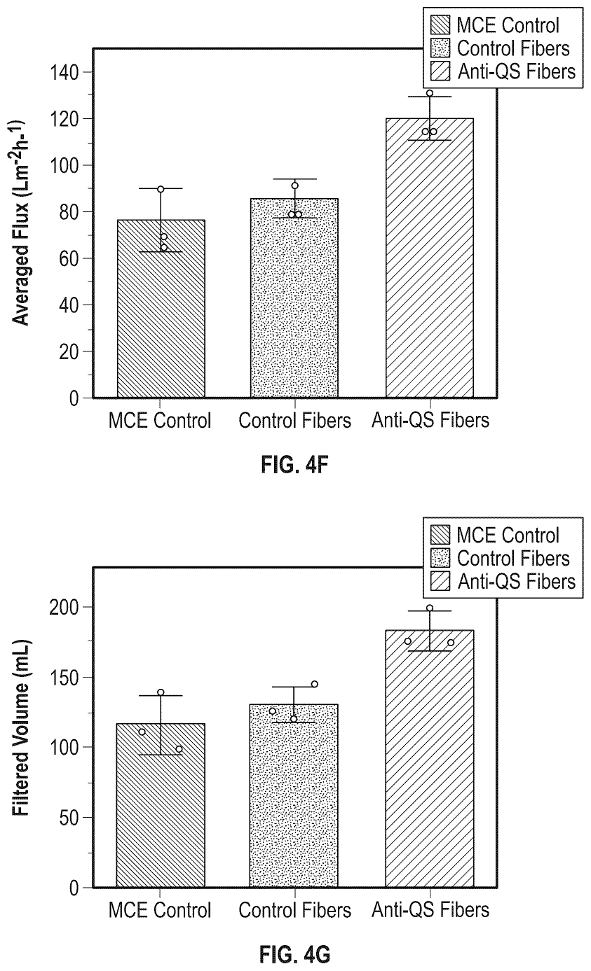

FIG. 4A is a confocal microscopy (CLSM) image showing the biofilm growth on the MCE Control and demonstrating a biofilm growth of 220 μm in thickness over a 581.25 μm×581.25 μm surface area after 4-hour operation. FIG. 4B is a confocal microscopy (CLSM) image showing the biofilm growth on the Control Fibers and demonstrating a biofilm growth of 200 μm in thickness over a 581.25 μm×581.25 μm surface area after 4-hour operation. FIG. 4C is a confocal microscopy (CLSM) image showing the biofilm growth on the Anti-QS Fibers and demonstrating a biofilm growth of 140 μm in thickness over a 581.25 μm×581.25 μm surface area after 4-hour operation.

FIG. 4D is a graph showing the biovolume (μm³/μm²) quantitative data and comparing the results for the MCE Control of FIG. 4A, Control Fibers of FIG. 4B, and Anti-QS Fibers of FIG. 4C and demonstrating the biovolume from greatest to lowest for the MCE Control, Control Fibers, and Anti-QS Fibers, respectively. FIG. 4E is a graph showing the thickness (μm) quantitative data and comparing the results for the MCE Control of FIG. 4A, Control Fibers of FIG. 4B, and Anti-QS Fibers of FIG. 4C and demonstrating the thickness from greatest to lowest for the MCE Control, Control Fibers, and Anti-QS Fibers, respectively.

FIG. 4F is a graph showing membrane performance in terms of water quantity output of average flux (L M⁻² h⁻¹) after operation and comparing the results for the MCE Control of FIG. 4A, Control Fibers of FIG. 4B, and Anti-QS Fibers of FIG. 4C and demonstrating the membrane performance from lowest to greatest for the MCE Control, Control Fibers, and Anti-QS Fibers, respectively. FIG. 4G is a graph showing the membrane performance in terms of water quantity output of filtered volume (mL) after operation and comparing the results the MCE Control of FIG. 4A, Control Fibers of FIG. 4B, and Anti-QS Fibers of FIG. 4C and demonstrating the membrane performance from lowest to greatest for the MCE Control, Control Fibers, and Anti-QS Fibers, respectively.

Accordingly, this example demonstrates that an electrospun coating comprising a polymer blend of a 3:1 PCL to PEG polymer ratio and associated with Urolithin A (200 μg/mL) provided desirable physical disruption in addition to molecular interruption of biofilm formation during filtration exhibiting a 83.48% reduction compared to the MCE Control. Moreover, the controlled release of anti QS molecules by electrospun fibers provided desirable anti-biofilm properties, increasing the biovolume by reduction by 26.05% and increasing flux by 52.78%.

### Example 3

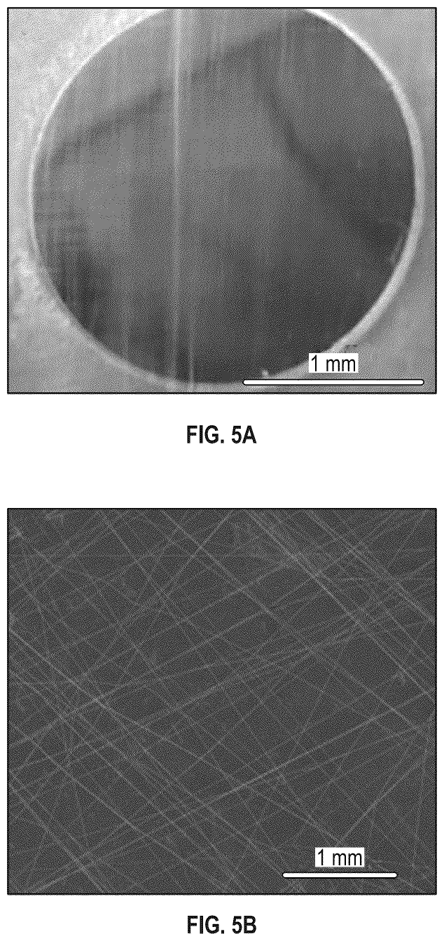

In this example, the association of electrospun fibers with Urolithin-A was investigated. FIG. 5A is an image of an electrospun filter comprising PCL/PEG fibers associated with one or more anti-QS Urolithin A molecules. FIG. 5B is an electron micrograph of the electrospun filter comprising PCL/PEG fibers associated with one or more anti-QS Urolithin A molecules of FIG. 5A.

Accordingly, this example demonstrates the association of the anti-QS Urolithin A molecules with the PCL/PEG fibers.

### Example 4

In this example, biofouling on filtration membranes was investigated by comparing membranes comprising a filter coating associated with one or more anti-QS Urolithin A molecules having concentrations of 50 μg/mL, 100 μg/mL, and 200 μg/mL.

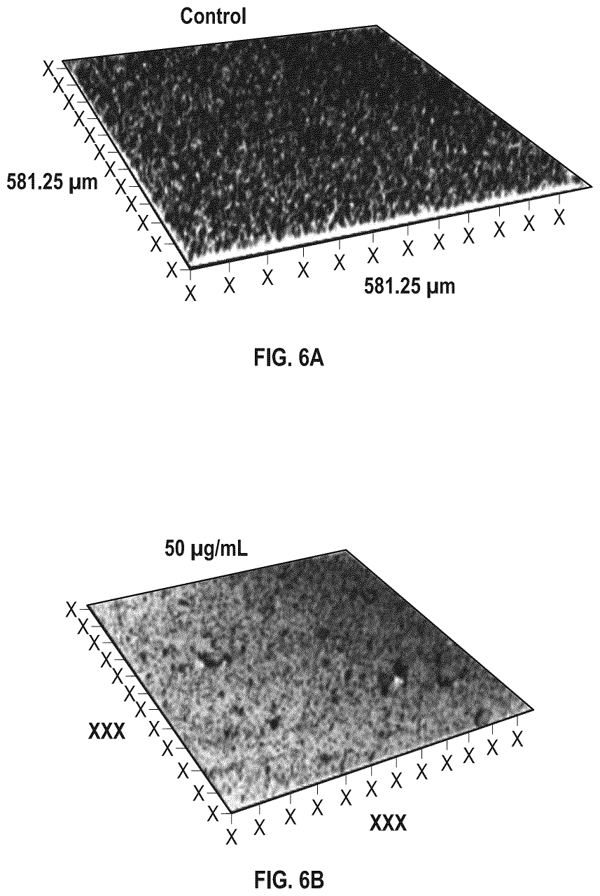

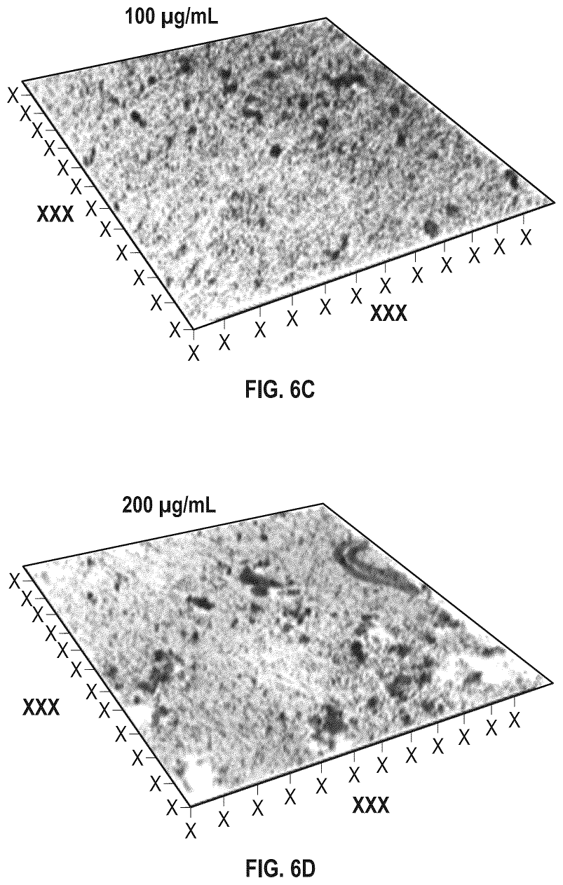

FIG. 6A is a confocal microscopy (CLSM) image showing the biofilm growth on an unmodified control membrane. FIG. 6B is a confocal microscopy (CLSM) image showing the biofilm growth on a membrane comprising electrospun PCL/PEG fibers associated with one or more anti-QS Urolithin A molecules (50 μg/mL). FIG. 6C is a confocal microscopy (CLSM) image showing the biofilm growth on a membrane comprising electrospun PCL/PEG fibers associated with one or more anti-QS Urolithin A molecules (100 μg/mL). FIG. 6D is a confocal microscopy (CLSM) image showing the biofilm growth on a membrane comprising electrospun PCL/PEG fibers associated with one or more anti-QS Urolithin A molecules (200 μg/mL).

Accordingly, this example demonstrates biofilm biovolume reduction corresponding to the increased concentrations of anti-QS Urolithin A molecules.

### Example 5

In this example, biofouling on filtration membranes was investigated by examining anti-quorum sensing molecules in P. aeruginosa (PAO1). More specifically, a membrane comprising an unmodified membrane (referred to “MCE Membrane”); a membrane (referred to as “MCE+PEG/PCL”) comprising a filter coating, which was deposited by electrospinning fibers comprising a polymer blend (3:1 polycaprolactone (PCL) to polyethylene glycol (PEG)); and a membrane (referred to as “MCE+PEG/PCL+Urolithin A” comprising a filter coating, which was deposited by electrospinning fibers comprising a polymer blend (3:1 polycaprolactone (PCL) to polyethylene glycol (PEG)) associated with one or more anti-QS molecules (200 μg/mL). Biofilm growth over a 4-hour operation was investigated and compared for the MCE Membrane, MCE+PEG/PCL, and MCE+PEG/PCL+Urolithin A.

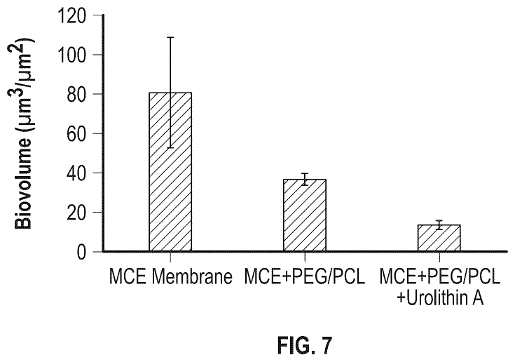

FIG. 7 is a graph showing biovolume quantitative data (μm³/μm²) and comparing the results of MCE Membrane, MCE+PEG/PCL, and MCE+PEG/PCL+Urolithin A. Accordingly, MCE+PEG/PCL+Urolithin A membrane exhibited a greater reduction in biofilm biovolume after a 4-hour filtration test (84%) relative to the MCE+PEG/PCL.

Therefore, this example demonstrates a greater reduction in biofilm biovolume for membranes comprising a filter coating, by electrospinning fibers comprising a PCL/PEG polymer blend associated with one or more anti-QS molecules.

### Example 6

In this example, a membrane comprising a filter coating, which was deposited by electrospinning fibers comprising a polymer blend (3:1 polycaprolactone (PCL) to polyethylene glycol (PEG)) associated with one or more anti-QS molecules furanone C-30 was compared to a control membrane comprising a filter coating, which was deposited by electrospinning fibers comprising a polymer blend (3:1 polycaprolactone (PCL) to polyethylene glycol (PEG).

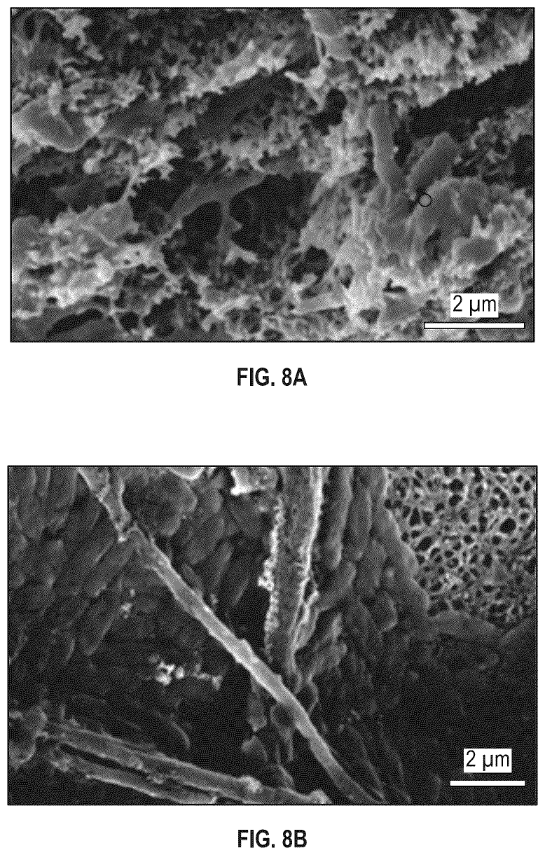

FIG. 8A is a scanning electron micrograph image showing the biofilm biovolume after a 4-hour filtration test of a MCE filter comprising electrospun PCL/PEG fibers. FIG. 8B is a scanning electron micrograph image showing the biofilm biovolume after a 4-hour filtration test of a MCE filter comprising electrospun PCL/PEG fibers associated with one or more anti-QS furanone C-30 molecules. After 4-hour filtration test the membrane comprising the electrospun PCL/PEG fibers associated with one or more anti-QS furanone C-30 molecules exhibited a reduction in biovolume of 57.5% when furanone C-30 was control-released relative to the control membrane.

Accordingly, this example demonstrates a greater reduction demonstrates a greater reduction in biofilm biovolume for membranes comprising electrospun PCL/PEG fibers blend associated with one or more anti-QS molecules comprising furanone C-30.

In view of the many possible aspects to which the principles of the present disclosure may be applied, it should be recognized that the illustrated embodiments are only preferred examples of the present disclosure and should not be taken as limiting the scope of the present disclosure. Rather, the scope of the present disclosure is defined by the following claims. We therefore claim as our invention all that comes within the scope and spirit of these claims.

We claim:

1. A composition, comprising:
a polymeric mixture comprising a hydrophobic component and a hydrophilic component, wherein the hydrophobic component has a lower water solubility than the hydrophilic component; and
one or more molecules for disrupting bacterial communication.

2. The composition of claim 1, wherein the polymeric mixture comprises a polymer blend, a block copolymer, or a block copolymer blend.

3. The composition of claim 1, wherein the hydrophobic component comprises polycaprolactone (PCL), polyethylene-co-octene (PE), polylactic acid (PLA), poly(1-lactide), polystyrene, poly(styrene-co-acrylonitrile) (PSA), poly(styrene-co-methyl methacrylate) (PSM), polymethyl methacrylate (PMMA), poly(vinylidene fluoride-co-trifluoroethylene), or any combination thereof; and wherein the hydrophilic component comprises polyethylene glycol (PEG), polyethylene oxide (PEO), poly(vinyl alcohol), poly(n-isopropylacrylamide) (PNIPAM), starch, chitosan, or any combination thereof.

4. The composition of claim 3, wherein the hydrophobic component comprises polycaprolactone (PCL) and the hydrophilic component comprises polyethylene glycol (PEG), and the polycaprolactone (PCL) and the polyethylene glycol (PEG) are present in amounts providing a polycaprolactone (PCL): polyethylene glycol (PEG) ratio of 3:1 to 1:3.

5. The composition of claim 3, wherein the hydrophobic component comprises polycaprolactone having a molecular weight ranging from 5,000 to 100,000; and wherein the hydrophilic component comprises polyethylene glycol having a molecular weight ranging from 200 to 1,000,000.

6. The composition of claim 1, wherein the one or more molecules for disrupting bacterial communication comprises an anti-quorum sensing molecule, a derivative, or analogue thereof; or a quorum quenching molecule, a derivative, or analogue thereof; or any combination thereof.

7. The composition of claim 1, wherein the one or more molecules for disrupting bacterial communication are selected from Urolithin A, Furanone C-30, Curcumin Longa, AHL-lactonase, embelin, Piperine, Piericidin A, Glucopiericidin A, Baicalein, Quercetin, or any combination thereof.

8. The composition of claim 7, wherein the one or more molecules for disrupting bacterial communication comprises Urolithin A having a concentration in the composition ranging from 1 μg/mL to 1000 μg/mL.

9. The composition of claim 1, wherein the one or more molecules for disrupting bacterial communication are incorporated into the polymeric mixture by mixing, sonication, or any combination thereof.

10. A membrane, comprising:
a substrate; and
a polymeric antibiofouling coating comprising:
a polymer blend, block copolymer, or block copolymer blend, and
one or more molecules for disrupting bacterial communication;
wherein the polymeric antibiofouling coating is deposited onto the substrate via electrospinning.

11. The membrane of claim 10, wherein the polymeric antibiofouling coating is an electrospun core-shell structure having a polymeric core comprising the one or more molecules for disrupting bacterial communication.

12. The membrane of claim 10, wherein the polymeric antibiofouling coating is an electrospun core-shell structure having a solid or powder-based core comprising the one or more molecules for disrupting bacterial communication.

13. The membrane of claim 10, wherein the polymeric antibiofouling coating is deposited as a film or sheet layer.

14. The membrane of claim 10, wherein the substrate comprises cellulose, mixed cellulose ester, polyamide, polyvinylidene fluoride (PVDF), polycaprolactone (PCL), polyether sulfone (PES), polytetrafluoroethylene (PTFE), polypropylene, polycarbonate, or any combination thereof.

15. The membrane of claim 10, wherein the polymeric antibiofouling coating comprises one or more fibers having a diameter ranging from greater than 0 μm to 10 μm.

16. The membrane of claim 15, wherein the one or more molecules for disrupting bacterial communication inhibit quorum sensing.

17. A method for inhibiting biofilm formation, the method comprising:
depositing the composition of claim 1 onto a substrate via electrospinning; and
exposing the substrate to an aqueous environment.

18. The method of claim 17, wherein the bacterial biofilm comprises Pseudomonas aeruginosa, Staphylococcus aureus, Staphylococcus epidermidis, Pseudomonas aeruginosa, Enterococcus faecalis, Escherichia coli, Klebsiella pneumoniae, Proteus mirabilis, Streptococcus viridans, Sphingomonas, Listeria monocytogenes, Salmonella spp., Clostridium perfringens, Bacillus spp., Shewanella putrefaciens, Cronobacter spp., Geobacillus stearothermophilus, or any combination thereof.

19. The method of claim 17, wherein the one or more small molecules are an anti-quorum sensing molecule; a derivative, or analogue thereof; or a quorum quenching molecule, a derivative, or analogue thereof; or any combination thereof.

20. The method of claim 18, wherein the one or more molecules for disrupting bacterial communication are selected from Urolithin A, Furanone C-30, Curcumin Longa, AHL-lactonase, embelin, Piperine, Piericidin A, Glucopiericidin A, Baicalein, Quercetin, or any combination thereof.
